(19) United States
(12) Patent Application Publication
(10) Pub. No.: US 2009/0314727 A1
(43) Pub. Date: Dec. 24, 2009

(54) FILTER ARRANGEMENT AND METHODS

(75) Inventors: John R. Hacker, Minneapolis, MN (US); Jodi Billy, Minneapolis, MN (US)

Correspondence Address: MERCHANT & GOULD PC, P.O. BOX 2903, MINNEAPOLIS, MN, 55402-0903, US

(73) Assignee: Donaldson Company, Inc., Minneapolis, MN (US)

(21) Appl. No.: 12/162,443

(22) PCT Filed: Feb. 6, 2007
(86) PCT No.: PCT/US07/02918

§ 371 Date: Dec. 15, 2008

Related U.S. Application Data
(60) Provisional application No. 60/765,961, filed on Feb. 7, 2006.

(51) Int. Cl. B01D 35/30; B01D 27/06; B01D 37/00

(52) U.S. Cl. 210/806; 210/347; 210/323.2; 210/232; 210/236

(57) ABSTRACT

A primary and secondary filter are combined into a single housing, and two elements are combined into a single element. This combination is useable in any system that has a filter upstream of a pump and a filter downstream of a pump. The example described is a fuel system.

This application is being filed on 6 Feb. 2007, as a PCT International Patent application in the name of Donaldson Company, Inc., a U.S. national corporation, applicant for the designation of all countries except the US, and John R. Hacker and Jodi Billy, both citizens of the U.S., applicants for the designation of the US only, and claims priority to U.S. Provisional Patent Application No. 60/765,961, filed Feb. 7, 2006.

### TECHNICAL FIELD

This disclosure relates to filter arrangements, systems, and methods. In particular, this disclosure relates to combining at least two filters into a single unit, in which one filter is on the upstream side of a pump, and a second filter is on a downstream side of a pump. In one example embodiment, the disclosure relates to a filter system useable in a fuel system.

### BACKGROUND

FIG. 1 depicts a prior art system. For many diesel engine powered vehicles, there are two fuel filters used in order to provide proper protection for the fuel system components (pumps and injectors). These systems move fuel from the fuel tank 10 through a primary (suction) filter 12 using a transfer pump 14. From pump 14, the fuel passes through a secondary (pressurized) filter 16 and onto the fuel injection system 18. The primary filter 12, on the suction side, usually removes water and some particulate matter. Since water is heavier than fuel, much of the water can separate from the fuel quickly if the flow rate is reduced (settling chamber) prior to reaching the filter media. The media in the primary filter 12 is treated with a substance that makes the media hydrophobic, which acts to strip some of the water out of the fuel before passing through the media. Another method is to add a layer of special media upstream of the standard media in the suction filter 12 which is designed to coalesce the water outside of the fuel. This water migrates down the dirty side of the media and eventually settles into a settling or collector chamber 20.

As a result of emission changes to diesel engines, fuel system pressures have significantly increased. This increased pressure creates a finer spray of fuel in the combustion chamber resulting in a more complete burn, which in turn, helps reduce emissions. Because of the higher pressure, fuel injector components have smaller clearances in their moving parts. These smaller clearances rely heavily on the fuel to maintain these clearances and lubricate during operation (preventing significant wear between the moving parts). Water has a lower film strength than fuel, which greatly decreases lubricating and provides an opportunity for the moving parts to come in contact with each other. At these higher pressures, even a small amount of water can accelerate the rate of wear of the injector components. With currently existing systems, there are two separate filter assemblies that need to be serviced during routine servicing, and they are usually at different locations on the vehicle. Improvements are needed.

### SUMMARY

A filter cartridge is provided including a casing having an outer surrounding wall defining an interior volume, first and second fluid inlet ports, and first and second fluid outlet ports. Each of the first inlet port, first outlet port, second inlet port, and second outlet port are fluidly isolated from each other. A first filter element is permanently secured within the interior volume of the casing. The first filter element has an upstream side in flow communication with the first inlet port and a downstream side in flow communication with the first outlet port. A second filter element is permanently secured within the interior volume of the casing. The first filter element and the second filter element are fluidly isolated from each other. The second filter element has an upstream side in flow communication with the second inlet and a downstream side in flow communication with the second outlet port.

In another aspect, a filter arrangement is provided including a filter cartridge as characterized above, a housing, and a pump. The housing defines an interior volume and an opening providing access to the interior volume. The filter cartridge is removably oriented in the interior volume of the housing. The housing defines a housing inlet port and a housing outlet port. The housing inlet port is in fluid communication with the first inlet port. The housing outlet port is in fluid communication with the second outlet port. The pump is oriented in the housing. The pump has a pump inlet port and a pump outlet port. The pump inlet port is in fluid communication with the first outlet port, and the pump outlet port is in fluid communication with the second inlet port.

In another aspect, a method of filtering is provided including sucking a liquid from a reservoir using a pump located in a housing through an inlet port in the housing, then through a first filter element located in the housing, and then through the pump. The method also includes pushing the liquid from the pump through a second filter element in the housing and then through an outlet port in the housing.

In another aspect, a method of servicing a filter arrangement is provided. The method includes releasing a lever to free a service handle, and pulling the service handle and removing a filter cartridge from operable engagement with a housing. The filter cartridge includes the type as characterized above.

In another aspect, a fuel system is provided. The fuel system includes a fuel tank, a fuel injection system, and a filter arrangement as characterized above.

### BRIEF DESCRIPTION OF THE DRAWINGS

FIG. 1 is a schematic depiction of a prior art fuel filter system;

FIG. 2 is a schematic depiction of a system constructed according to principles of this disclosure;

FIG. 3 is a perspective view of a filter arrangement constructed according to principles of this disclosure;

FIG. 4 is another perspective view of the filter arrangement depicted in FIG. 3;

FIG. 5 is another perspective view of the filter arrangement depicted in FIGS. 3 and 4 and showing one step of the method of servicing the filter arrangement;

FIG. 6 is a perspective view of the filter housing useable with the filter arrangement of FIGS. 3-5;

FIG. 7 is another perspective view of the filter housing depicted in FIG. 6;

FIG. 8 is a perspective view of a service handle, a cover, and a filter cartridge useable with the filter arrangement depicted in FIGS. 3-5;

FIG. 9 is a top plan view of the filter arrangement depicted in FIGS. 3-5;

FIG. 10 is a cross-sectional view of the filter arrangement depicted in FIG. 9, the cross-section being taken along the line 10-10 of FIG. 9;

FIG. 11 is a bottom plan view of the filter arrangement depicted in FIGS. 3-5;

FIG. 12 is a cross-sectional view of the filter arrangement, the cross-section being taken along the line 12-12 of FIG. 11;

FIG. 13 is a top plan view of the filter housing depicted in FIG. 7;

FIG. 14 is a cross-sectional view of the filter housing of FIG. 13, the cross-section being taken along the line 14-14 of FIG. 13;

FIG. 15 is a side elevational view of the filter housing of FIGS. 13 and 14;

FIG. 16 is a cross-sectional view of the filter housing of FIG. 15, the cross-section being taken along the line 16-16 of FIG. 15;

FIG. 17 is a perspective view of the filter cartridge useable in the filter arrangement of FIGS. 3-5;

FIG. 18 is an enlarged view of the portion of the filter cartridge depicted in FIG. 17;

FIG. 19 is a top plan view of the filter cartridge depicted in FIG. 17;

FIG. 20 is a cross-sectional view of the filter cartridge depicted in FIG. 19, the cross-section being taken along the line 20-20 of FIG. 19;

FIG. 21 is a side elevational view of the filter cartridge depicted in FIG. 17;

FIG. 22 is a schematic cross-sectional view and showing flow paths through the filter cartridge, the cross-section being taken along the line 22-22 of FIG. 21; and

FIG. 23 is a schematic cross-sectional view and showing flow paths through the filter cartridge, the cross-section being taken along the line 23-23 of FIG. 21.

### DETAILED DESCRIPTION

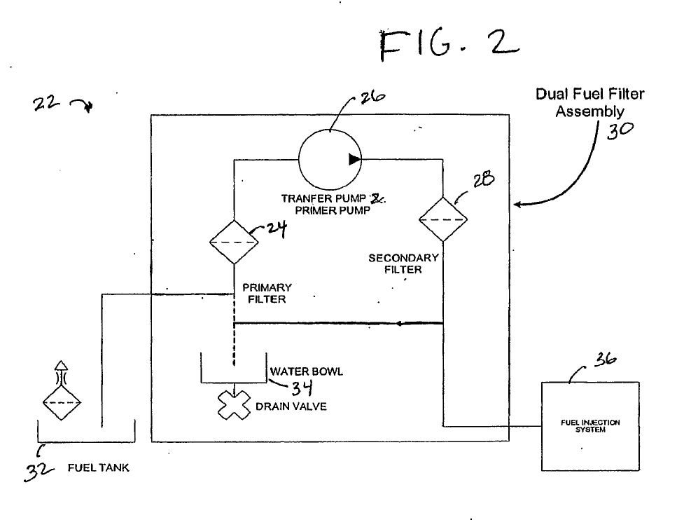

### A. Example Fuel Circuit System, FIG. 2

FIG. 2 depicts a schematic of a fuel circuit system 22. While a fuel system 22 is depicted, it should be understood that any system which utilizes a filter on a suction side of a pump and a filter on a pressurized side of a pump could be used. The fuel system 22 depicted is just one example.

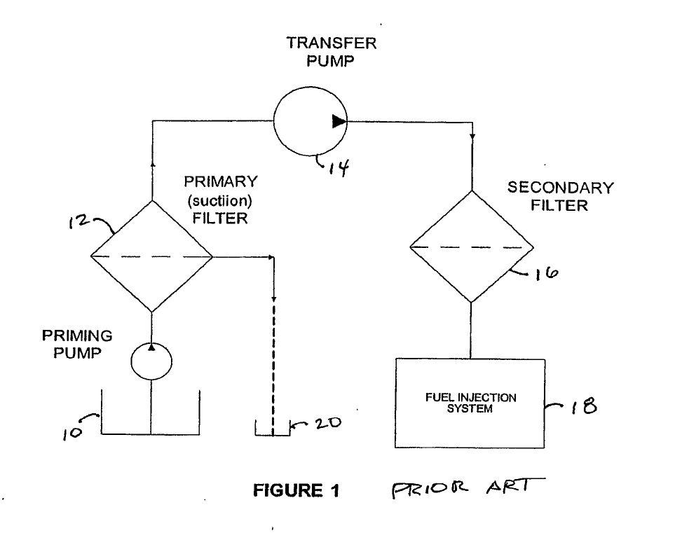

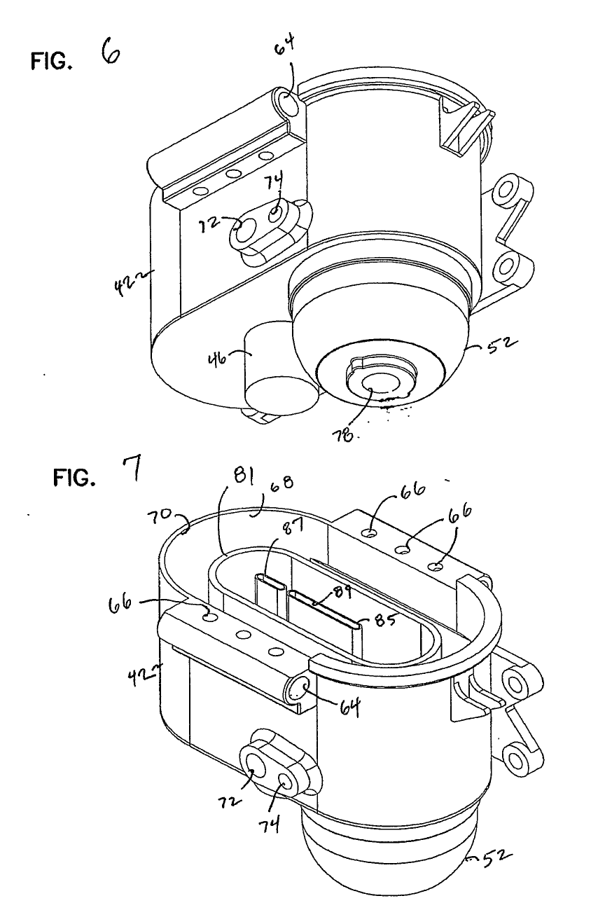

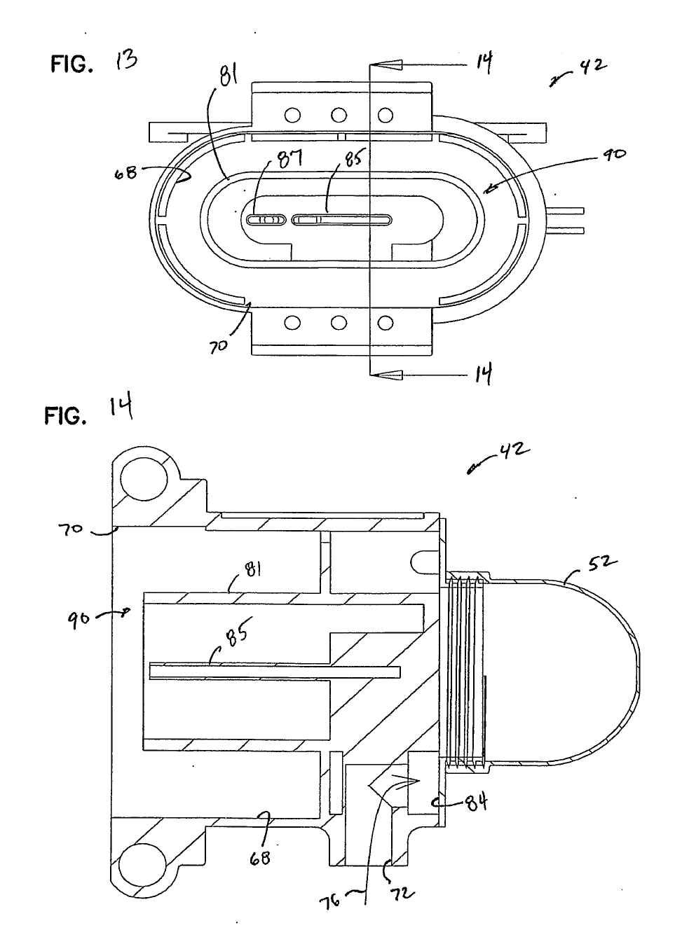

In FIG. 2, a suction or primary filter 24 is depicted on the suction side or upstream side of a pump arrangement 26, and a pressurized or secondary filter 28 is shown on the downstream side of the pump arrangement 26. In the example embodiment depicted in FIGS. 3-23, the pump arrangement 26 does both functions of a transfer pump and a primer pump. In FIG. 2, the primary filter 24 and the secondary filter 28 are part of a single, unitary housing 30. In preferred embodiments, described further, the primary filter 24, secondary filter 28, and pump 26 are combined together into a single filter element. The single filter element costs less to produce than two separate elements. In addition, the time it takes to service the single combined filter element is shorter than servicing two separate units, as shown in the prior art FIG. 1.

As stated above, in the embodiment of FIGS. 3-23, a combination transfer pump and primer pump is used at 26. The primer pump is used specifically to prime the system after a filter has been replaced. Air is trapped in the fuel system after a filter has been replaced, and the primer pump is used to prime the fuel system. In FIG. 2, an electric drive transfer pump is useable as the pump arrangement 26. The electric drive transfer pump is used to prime the system without the need to turn the engine over.

Also depicted in FIG. 2 is a fuel tank 32, a drain assembly 34, and a fuel injection system 36. The pump arrangement 26 draws fuel from the fuel tank 32 and into the primary filter 24. The primary filter 24 removes at least some water from the fuel. The water drains to the drain assembly 34. The primary filter 24 also removes at least some particulate material from the fuel. The filtered fuel is then pushed by the pump arrangement 26 through the secondary filter 28. The secondary filter 28 filters the fuel before the fuel is conveyed to the fuel injection system 36.

### B. Example Embodiment of Filter Arrangement, FIGS. 3-5, 9, and 10

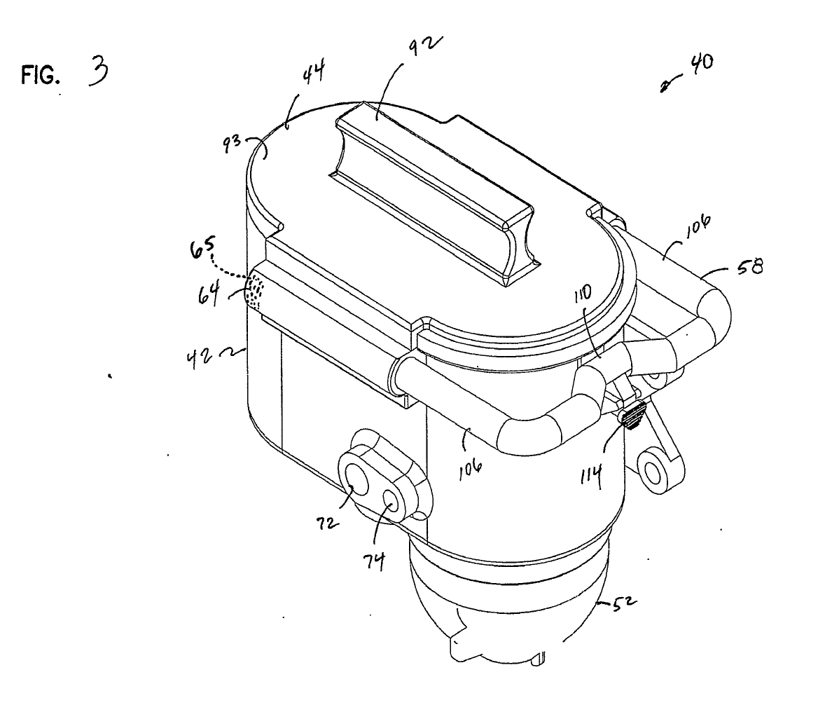

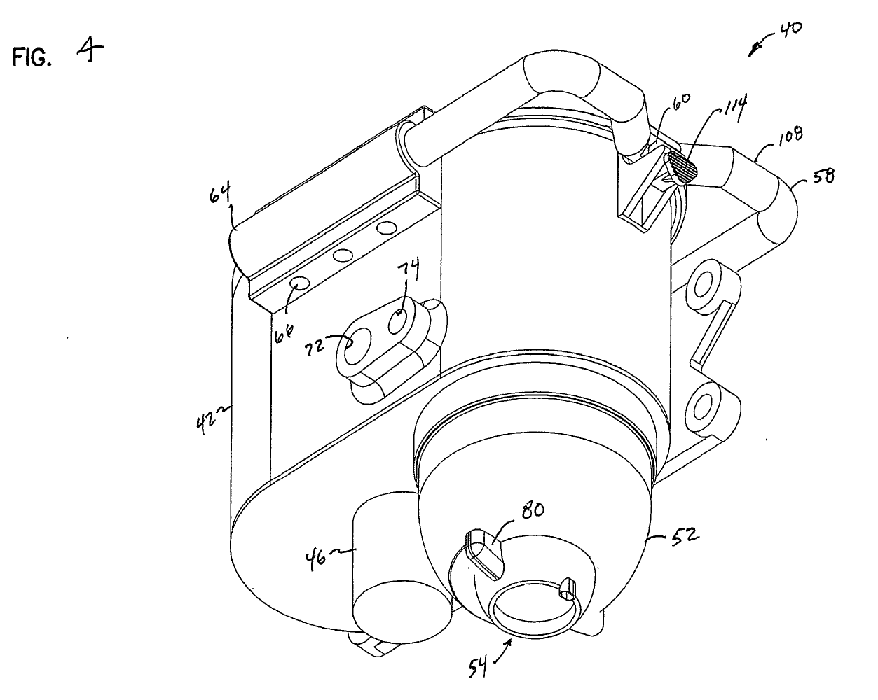

In FIG. 3, a filter arrangement is shown generally at 40. In the embodiment shown, the filter arrangement 40 includes an outer housing 42, a removable cover 44, a pump 46 (FIG. 4), and a removable and replaceable filter cartridge 50 (FIGS. 5, 8, and 17-23). The filter arrangement 40 also includes, in the embodiment depicted in FIGS. 3-5, a liquid collection bowl 52 with a valve assembly 54 (FIG. 4) and a locking arrangement 56 to permit selective operable installation and removal of the filter cartridge 50 relative to the housing 42. Some of the components of the locking arrangement 56 depicted includes a service handle 56, a locking lever 60 (FIG. 5), a plurality of pegs 62 (FIG. 5) extending from the cover 44, a channel 64 defined by the housing 42 including a plurality of holes 66 in communication with the channel 64 and sized to receive the pegs 62. Further description of the locking arrangement 56 and its operation is described below.

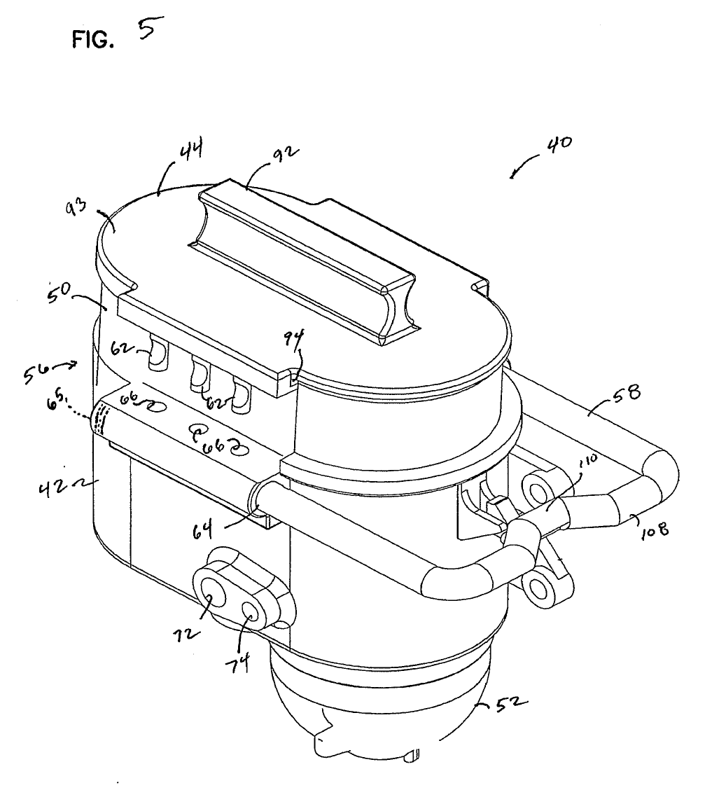

The housing 42 defines an interior volume 68 (FIGS. 7 and 12-14) and an opening 70 to provide access to the interior volume 68. The filter cartridge 50 is removably oriented in the interior volume 68 and is installable in the housing 42 through the opening 70. The housing 42 includes a housing inlet port 72 and a housing outlet port 74. The inlet port 72 is in fluid communication with fuel tank 32 (FIG. 2), such that the liquid to be filtered, such as fuel, is drawn from the fuel tank 32 by the pump 46 in through the inlet port 72. From there, the liquid, such as fuel, passes through the filter cartridge 50, and then exits the filter arrangement 40 through the housing outlet port 74. From there, the liquid, such as fuel, is directed to fuel injection system 36 (FIG. 2).

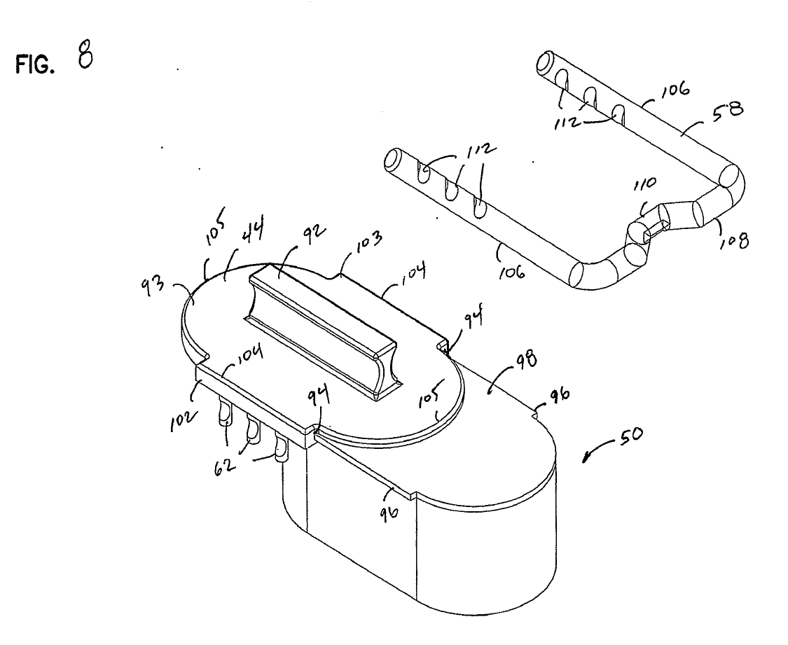

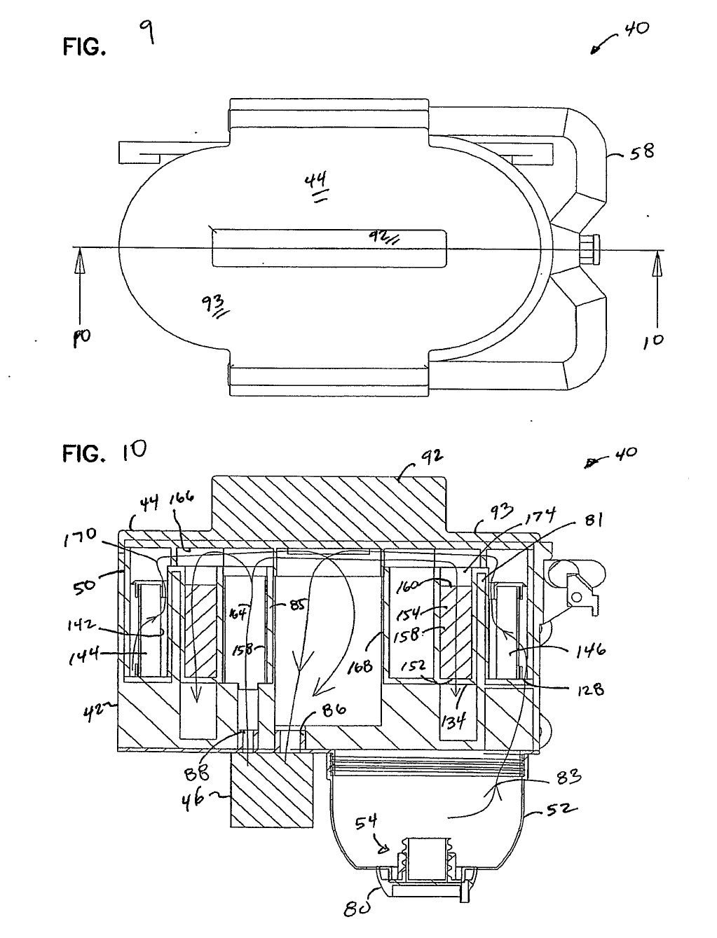

Turning now to FIGS. 11-16, certain internal components and flow channels in housing 42 are described. FIG. 11 depicts a bottom plan view of the housing 42. FIG. 12 is a cross-sectional view taken through FIG. 11. In FIG. 12, the inlet port 72 is depicted, and arrow 76 shows the flow of liquid initially into the housing 42 through the inlet port 72. The liquid will flow through the port 72 and then flow downwardly into the liquid collection bowl 52. The liquid collection bowl 52 has an opening 78, which accommodates the valve assembly 54 (FIG. 10) to allow for the draining and removal of water in the bowl 52. The valve assembly 54 can be any of a variety of constructions that will permit drainage from the bowl 52, either manual or automatic. One useable manual valve assembly 54 is described in commonly assigned pending U.S. patent application Ser. No. 11/202,736, filed Aug. 11, 2005, which application is incorporated herein by reference. The drain valve assembly 54 includes a knob 80, which is rotatable relative to the bowl 52, and upon rotation of the knob 80, channels will align and open to allow drainage of the water from the bowl 52 through the valve assembly 54 (see FIG. 10). FIG. 12 also shows the liquid being drawn from the bowl 52 into primary filter region 82, at arrow 83. The pump 46 will draw the liquid from the bowl 52 and into the primary filter region 82. As will be described below, a portion of the filter cartridge 50 is situated within the primary filter region 82 and will filter the liquid in this region.

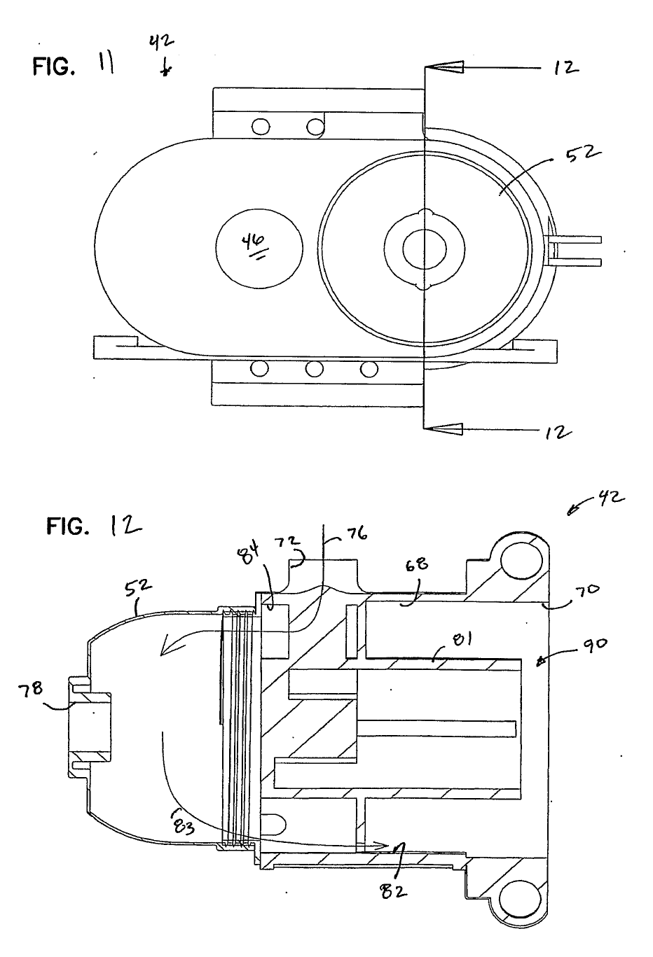

FIG. 13 depicts a top plan view of the filter housing 42, without the filter cartridge 50 situated therein. FIG. 14 is a cross-sectional view through a portion of FIG. 13. In FIG. 14, the inlet port 72 is depicted with inlet flow 76 flowing therethrough. The inlet flow 76 is directed into an inlet flow channel 84 (FIGS. 12, 14, and 16), and from inlet flow channel 84 is directed into the filter bowl 52. As mentioned above, from the bowl 52, the liquid is drawn into the primary filter region 82. From there, the liquid is directed to the pump 46 through pump inlet port 86 (FIG. 16). Certain internal structure in the filter cartridge 50 provides flow channels to direct the fluid to the pump inlet port 86. These cartridge features are described further below.

In FIGS. 7 and 13, it can be seen how the housing 42 includes a first wall 81, which separates a primary filter 144 from a secondary filter 154, each described further below. The first wall 81 generally has a shape of an inner dimension of a primary filter 144, in this case, racetrack shaped. The filter housing 42 further includes, within the first wall 81, an outlet wall 85 and an inlet wall 87. In the embodiment shown, the outlet wall 85 is racetrack shaped, but elongated and narrow to define a flow slot 89. Laterally adjacent to the outlet wall 85 is inlet wall 87. Inlet wall 87 is also racetrack shaped, but has a smaller cross-sectional area than outlet wall 85. When the filter cartridge 50 is installed within the housing 42, fluid that has been filtered through the primary filter 144 is directed into the slot 89 of the outlet wall 85, where it is directed to the pump inlet port 86. From the pump 46, the liquid is directed through a pump outlet port 88 (FIG. 16) and into the passage defined by the inlet wall 87. From there, the liquid flows to the secondary filter 154. From the secondary filter 154, the liquid passes through the housing outlet port 74. In general, the first wall 81, outlet wall 85, and inlet wall 87 are part of housing internal wall structure 90.

In reference again to FIGS. 3, 5, and 8-10, the cover 44 is depicted as generally flat with a handle 92 projecting from an outer surface 93. In FIG. 8, it can be seen that in the cover 44 depicted, the cover 44 defines a pair of slide grooves 94 to allow for slidably engaging and disengaging from the filter cartridge 50. The filter cartridge 50 includes a pair of projecting flanges 96 extending from a closed upper portion 98 of the filter cartridge 50. It should be understood that the groove 94 and flange 96 could be reversed. Also viewable in FIGS. 5 and 8, the pegs 62 can be seen projecting from the perimeter 102 in an axial direction. In particular, the pegs 62 project axially in a direction opposite from the axial direction of the handle 92. The cover 44 is symmetrical, in that the pegs 62 shown in FIG. 8 are also on the opposite side 103 of the cover 44. In the embodiment depicted, the cover 44 is non-circular in shape, specifically, generally racetrack or obround in shape. The pegs 62 project from the straight sections 104 of the cover. The straight sections extend between rounded ends 105. As mentioned above, the pegs 62 are part of locking arrangement 56, which will be described further below.

### C. Locking Arrangement 56

As mentioned above, the filter arrangement 40 preferably includes locking arrangement 56. The locking arrangement permits the selective operable installation and removal of the filter cartridge 50 relative to the housing 42. A variety of locking arrangements are useable. In the embodiment shown, the locking arrangement includes the service handle 58, locking lever 60, pegs 62, channel 64, and holes 66. Attention is directed to FIG. 8. The service handle 58 is shown as generally U-shaped, with a pair of parallel bars 106 and a base 108. The base 108 includes an indent 110, which cooperates with the locking lever 60. Each of the bars 106 defines a plurality of notches 112.

The bars 106 of the service handle 58 are sized to be slidable within the channel 64 (FIGS. 3-7) such that the notches 112 align with the holes 66 and permit the pegs 62 on the cover 44 to pass through the holes 66 and the notches 112. In preferred arrangements, the service handle 58 is spring-biased into the channel 64. That is, in preferred arrangements, a spring 65 (shown in hidden lines in FIGS. 3 and 5) is oriented within the channel 64 to bias the handle 58 into the channel 64.

The locking lever 60 is secured to the housing 42 and is spring-loaded relative to the housing 42. The locking lever 60 includes a thumb press 114 (FIGS. 3 and 4) to allow for engagement with a user's hand, such as a thumb, and move the lever 60 from locking engagement (FIGS. 3 and 4) to unlocking engagement (FIG. 5). As can be seen in FIGS. 4 and 5, the locking lever 60 cradles and holds the indent 110 of the base 108 of the service handle 58. Pushing the thumb press 114 against the spring (not depicted) allows the service handle 58 to slide within and from the channel 64, against the spring 65. The handle 92 on the filter cartridge 50 is grasped and moved laterally within the channel 64 against the spring 65 (hidden lines, FIGS. 3 and 5) to move the notches 112 and align the pegs 62 with the holes 66. The filter cartridge 50 is moved axially relative to the housing 42 to move the pegs 62 from the holes 66. To secure the filter cartridge 50 within the housing 42, the pegs 62 are aligned with the holes 66, and the service handle 58 is slid (pulled by the spring 65) within the channel 64 until the notches 112 align with the pegs 62 and holes 66. This alignment allows the cartridge 50 to drop into operable engagement in the housing 42. The locking lever 60, being spring loaded, snaps up and partially around indent 110 of the handle 58 to lock the handle 58 in position with the filter cartridge 50 operably installed.

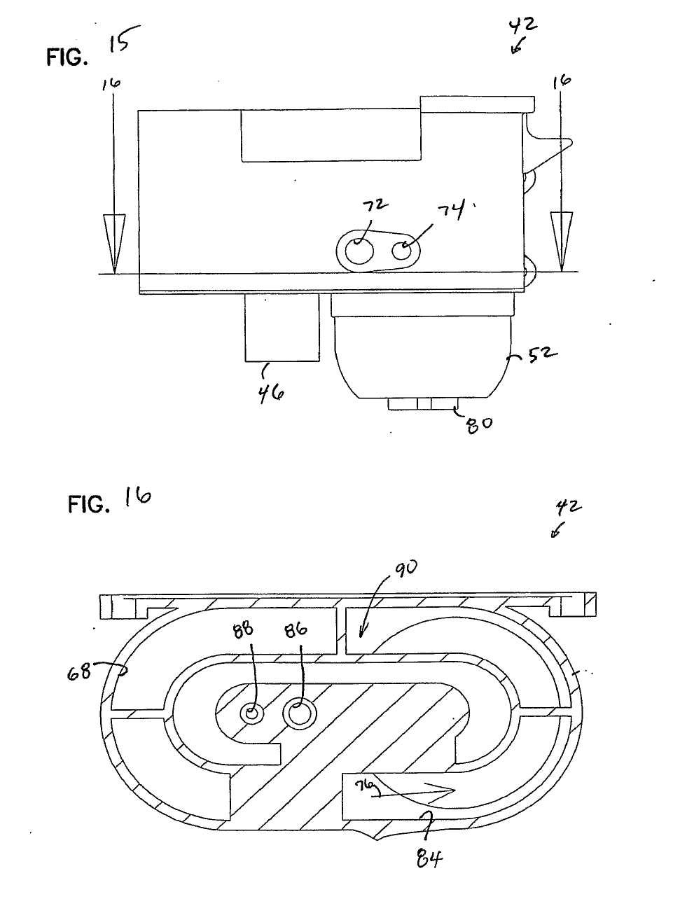

### D. Filter Cartridge 50, FIGS. 17-23

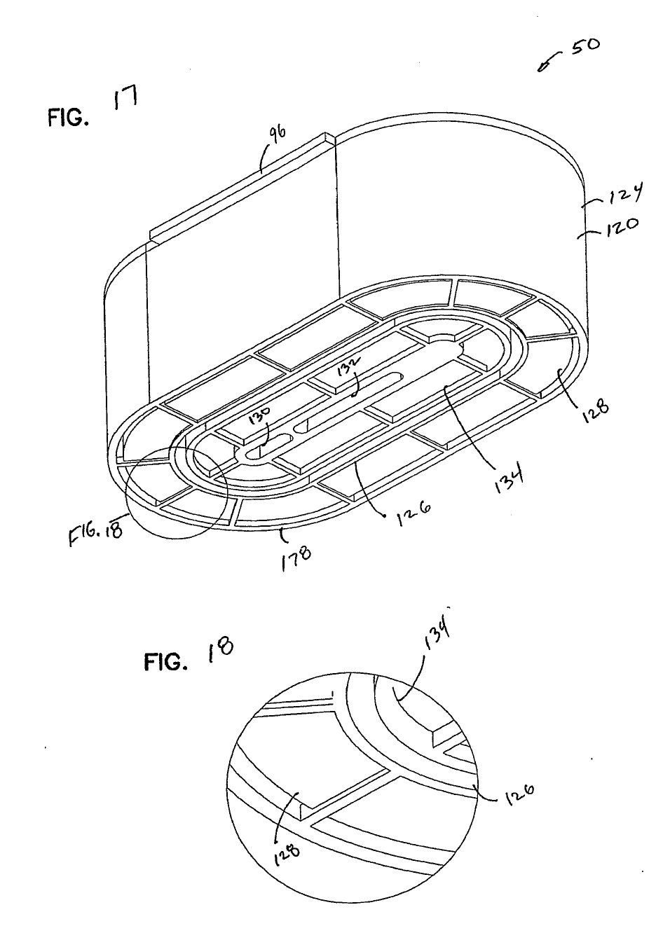

FIGS. 17-23 show one example filter cartridge 50. Other embodiments are useable. In the particular embodiment shown, the overall shape of the cartridge 50 is racetrack shaped with rounded ends 116 joined by sides 118 (see FIG. 19). The sides 118 include projecting flanges 96, which cooperate with grooves 94 on the cover 44 (FIG. 8).

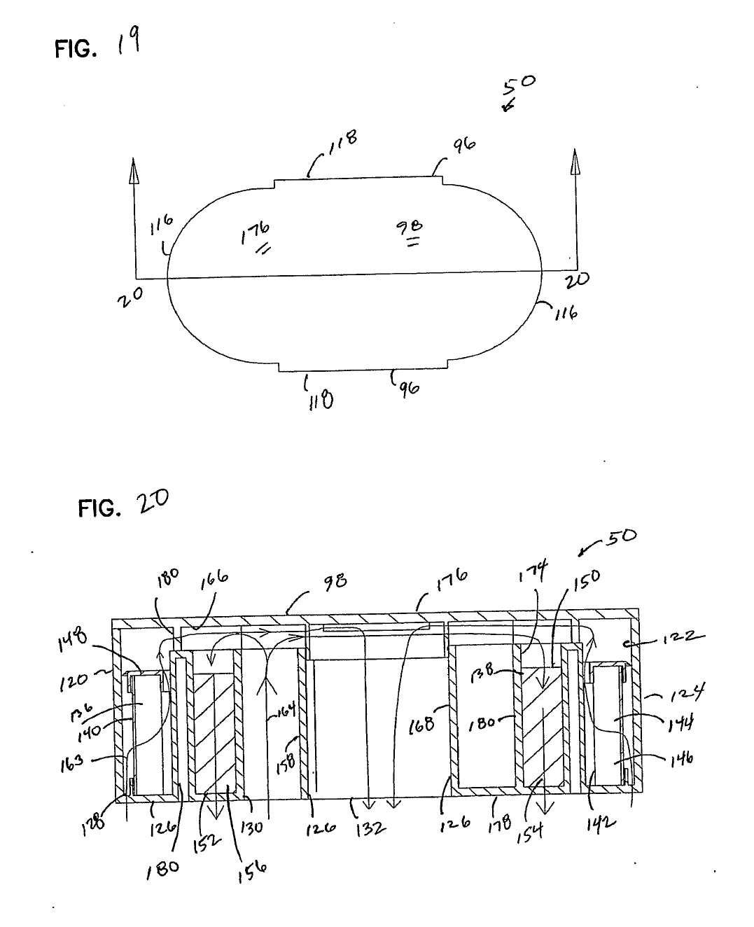

The filter cartridge 50 includes an outer surrounding wall 120 defining an interior volume 122 (FIGS. 20, 22, and 23). The outer surrounding wall 120 is part of a filter cartridge housing or casing 124, which also includes internal walls 126 (FIG. 20) in the interior volume 122.

The filter cartridge 50 also includes first and second fluid inlet ports 128, 130 (FIG. 17) and first and second fluid outlet ports 132, 134 (see FIGS. 17 and 20). Each of the first inlet port 128, first outlet port 132, second inlet port 130, and second outlet port 134 is fluidly isolated from each other. By “fluidly isolated”, it is meant that the fluid that flows through these ports is separated by, at least, filtration media, and the first inlet port 128 and first outlet port 132 are completely separated from the second inlet and outlet ports 130, 134. It should be understood that the positions of the inlet and outlet ports can be reversed.

In the preferred embodiment depicted, the filter cartridge 50 includes first and second filter elements 136, 138 permanently secured within the interior volume 122 of the casing 124. By “permanently secured”, it is meant that the filter elements 136, 138 are not removable and replaceable within the casing 124, without destroying the casing 124 or the filter elements 136, 138. In the embodiment shown, the first filter element 136 has an upstream side 140 that is in fluid flow communication with the first inlet port 128. The first filter element 136 also has a downstream side 142 in fluid flow communication with the first outlet port 132.

In the embodiment depicted, the first filter element 136 functions as a primary filter 144, analogous to primary filter 24 depicted in FIG. 2. In the example embodiment depicted, the primary filter 144 comprises pleated media 146 extending between end cap 148 (FIG. 20) and wall 126 of casing 124.

The second filter element 138 has an upstream side 150 in fluid flow communication with the second inlet port 130. It has a downstream side 152 in fluid flow communication with the second outlet port 134. In the example shown, the second filter element 138 functions as a secondary filter 154, analogous to secondary filter 28 depicted in FIG. 2. While a variety of configurations are useable, in the embodiment depicted, the secondary filter 154 has non-pleated media 156 configured for axial fluid flow. Such media can include Z-filter media as described in, for example, U.S. Pat. No. 6,783,565, incorporated herein by reference. Alternatively, the media 156 can include a plurality of layers of a filtration material stacked or wound in a spiral, wherein each layer is separated by a screen, and opposite alternating axial ends are blocked with a closure. In the example shown in FIG. 20, fluid, such as fuel, enters the second inlet port 130, through an inlet channel 158 defined by walls 126, where it is directed to a first axial end 150 of the secondary filter 154. The fluid then flows through the non-closed, open axial ends of the media 156 and exits the non-closed open axial ends at the second axial end 152, corresponding to the downstream side 152. From there, the fluid exits the filter cartridge 50.

In the illustrated embodiment, the primary element 144 and secondary element 154 are each non-round in cross-section. While a variety of geometries and shapes could be used, in the arrangement shown, the primary element 144 and the secondary element 154 is each obround in cross-section. Specifically, each is racetrack shaped, meaning there are a pair of rounded ends joined by straight sides, as shown in FIG. 19 as the overall shape of the filter cartridge 50.

The first filter element 136, functioning as the primary filter 144, circumscribes the second filter element 138 (functioning as the secondary filter 154). This can be seen in FIG. 20. Each of the elements 136, 138 has an overall same shape, in the shape of a racetrack, but are different sizes.

As can be seen in FIG. 20, the internal wall structure 126 of the casing 124 functions to separate the first filter element 136 from the second filter element 138. FIG. 20 also shows, in general, the flow path of liquid through the cartridge 50. Liquid from the fuel tank 32 is shown entering the cartridge at arrow 163. The liquid then flows through the primary filter media 146, through channel 166, through channel 168, and then through the first outlet port 132. From there, the liquid flows through the pump 46 in the filter arrangement 40. The liquid is pressurized by the pump 46 and directed through the second inlet port 130, through the channel 158 shown at arrow 164, and to the first axial end 160 of the secondary filter 154. From there, the liquid flows through the media 156, through the second axial end 162, then exits the filter cartridge 50 through the second outlet port 134.

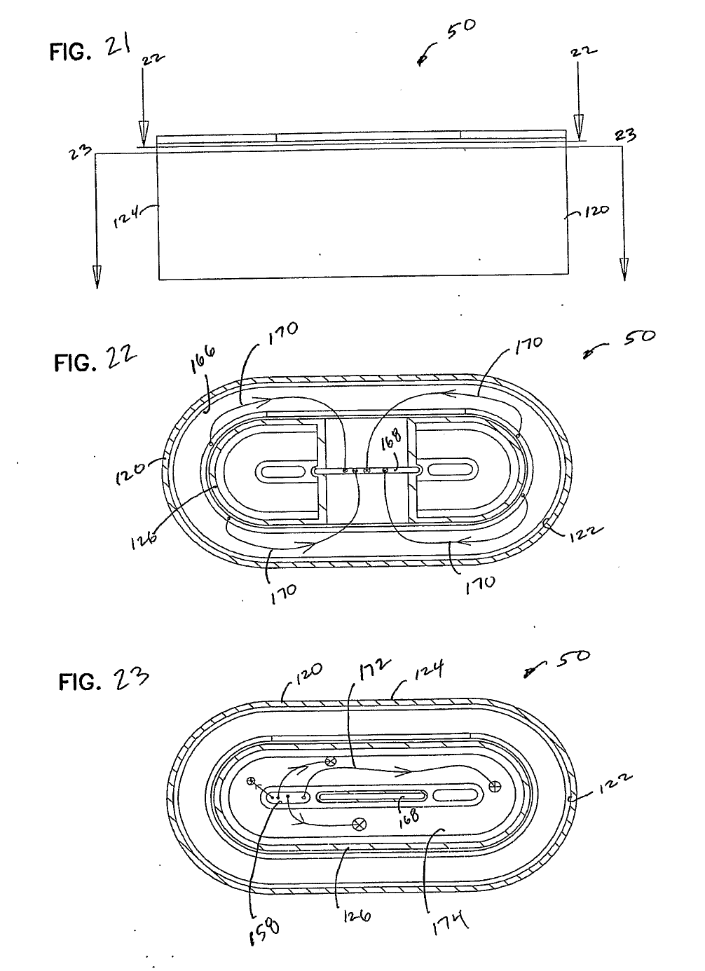

FIGS. 22 and 23 show flow paths through the cartridge 50. In FIG. 22, arrows 170 show liquid exiting the downstream side 142 of the primary filter element 144 and flowing in channel 166 until reaching central channel 168. The liquid shown at arrows 170 flows downwardly through the channel 168 to exit through the first outlet port 132 (FIGS. 17 and 20). FIG. 23 shows the liquid emerging from channel 158, which, in the example shown, is fuel pressurized by the pump 46. The liquid is shown at arrow 172. The liquid flows in volume 174 and then reaches the first axial end 160 of the secondary filter 154. From there, the liquid flows downward through the media 156 and exits the cartridge 50 through the second outlet port 134 (FIG. 17).

As should be appreciated by reviewing FIGS. 17-20, the filter cartridge 50 has a first axial end 176 and a second axial end 178. The first axial end 176 is closed by closed upper portion 98. The second axial end 178 is open defining the first inlet port 128, second inlet port 130, first outlet port 132, and second outlet port 134. The wall structure 126, in the embodiment shown, is viewable at the second axial end 178. The wall structure extends from the second axial end 178 at least partially to the first axial end 176. Walls 180 project from the internal surface of the first axial end 176 to close certain internal channels to flow therethrough.

### E. Operation and Methods

FIG. 10 shows the filter cartridge 50 operably installed within the housing 42. The first inlet port 128 of the cartridge 50 is in flow communication with the inlet port 72 and inlet flow channel 84. Liquid is shown at arrow 83 from the collection bowl 52 being sucked by the pump 46 through the primary filter media 146. In certain applications, when the primary filter 144 is used as a primary filter in a fuel system 36, the media 146 of the primary filter 144 will be treated with a material that will separate water from fuel. The water drips by gravity down to the collection bowl 52 where it is collected. The bowl 52 also acts as a settling chamber allowing water to separate from the fuel and settle to the bottom of the bowl 52. The primary filter media 146 also removes some particulate matter, but due to a generally low pressure drop caused by being located on the suction side of the pump 46, particle efficiency is not high.

From the downstream side 142 of the primary filter 144, the liquid flows into channel 166, shown at arrow 170. From there, the liquid flows through the channel 168 and exits the filter cartridge 50. From there, the liquid flows into the pump inlet port 86, through the pump 46, where it is pressurized, and then pushed through the pump outlet port 88. From there, the liquid flows as shown at arrow 164 through channel 158, into volume 174, and then to the first axial end 160 of the secondary filter 154. The liquid then flows through the media 158 and exits the cartridge at second outlet port 134. From there, the liquid flows through the housing outlet port 74, and is directed to downstream equipment, such as fuel injection system equipment 36.

After a period of use, it will be appropriate to service the filter arrangement 40. A method of servicing includes releasing lever 60 to free the service handle 58. The service handle 58 is pulled to align the pegs 62 with the holes 66, and the filter cartridge 50 is removed from operable engagement with the housing 42 by using the cover handle 92 to pull the filter cartridge 50 from operable installation within the housing 42. The step of releasing a lever includes pushing the lever 60 against a spring biased against the housing 42. The handle 92 secured to the filter cartridge 50 is grasped to move the cartridge 50, such that the pegs 62 are moved from engagement with notches 112 on the service handle 58. Sliding the service handle 58 laterally away from the housing 42 allows for the notches 112 to align the pegs 62 with the holes 66, which allows the cartridge 50 to be removed from the housing 42.

The old filter cartridge 50 is then discarded. A new filter cartridge 50 is installed by orienting it through the opening 70 and aligning the inlet and outlet ports 128, 130, 132, 134 with the proper flow channels in the housing 42. The service handle 58 is then slid laterally within the channel 64 (pulled laterally away from the housing 42 against the spring 65) such that the notches 112 align with the holes 66, and the pegs 62 can pass through the holes 66. The spring 65 pulls the service handle 58 inwardly, such that the notches 112 push against the pegs 62. The locking lever 60 then springs into place to hold and secure the indent 110 of the service handle 58 and lock the service handle 58 and the cartridge 50 in place. The filter arrangement 40 is again ready for use.

### F. Inventive Concepts/Principles

A filter cartridge (50) comprising a cartridge casing (42) including an outer surrounding wall (120) defining an interior volume (122); a first filter element (136) permanently secured within the interior volume of the cartridge casing; and a second filter element (138) permanently secured within the interior volume of the cartridge casing; the filter cartridge characterized by: the cartridge casing includes first and second fluid inlet ports (128, 130), and first and second fluid outlet ports (132, 134); each of the first inlet port, first outlet port, second inlet port, and second outlet port being fluidly isolated from each other; the first filter element has an upstream side (140) in flow communication with the first inlet port and a downstream side (142) in flow communication with the first outlet port; the first filter element and the second filter element are fluidly isolated from each other; and the second filter element has an upstream side (150) in flow communication with the second inlet port and a downstream side (152) in flow communication with the second outlet port. At least the second filter element comprises non-pleated media (156) configured for axial flow. The cartridge casing includes wall structure (126) in the interior volume of the outer surrounding wall separating the first filter element and the second filter element. The first filter element circumscribes the second filter element. The first filter element comprises pleated media (146) in a tubular shape with an open filter interior; and the second filter element is oriented in the open filter interior of the first filter element. The first filter element and the second filter element are each non-round in cross-section. The first filter element and the second filter element are each obround in cross-section. The cartridge has first and second axial ends (176, 178); the first axial end being closed; and the second axial end being open and defining the first inlet and outlet port and the second inlet and outlet port. The first filter element and the second filter element are separated within the cartridge by wall structures (126) extending from the second axial end at least partially to the first axial end.

A filter arrangement comprising a cartridge (50), as characterized above; a housing (42) defining an interior volume (68) and an opening (70) providing access to the interior volume; the filter cartridge being removably oriented in the interior volume of the housing; the housing defining a housing inlet port (72) and a housing outlet port (74); the filter arrangement characterized by: the housing inlet port (72) is in fluid communication with the first inlet port (128); the housing outlet port (74) is in fluid communication with the second outlet port (134); and a pump (46) is oriented in the housing; the pump having a pump inlet port (86) and a pump outlet port (88); the pump inlet port (86) being in fluid communication with the first outlet port (132); and the pump outlet port (88) being in fluid communication with the second inlet port (130). A cover (44) is removably oriented over the opening in the housing; and the cover being removably secured to the filter cartridge. A locking arrangement (56) permits selective operable installation and removal of the filter cartridge relative to the housing. The locking arrangement (56) includes: a plurality of pegs (62) extending from the cover (44); a channel (64) defined by the housing; the housing also including a plurality of holes (66) in communication with the channel (64); the holes (66) sized to receive the pegs (62); and a service handle (58) including a plurality of notches (112); and (b) the service handle (58) is slidable in the channel (64) defined by the housing such that the notches (112) align with the holes (66) and permit the pegs (62) on the cover (44) to pass through the holes (66) and notches (112). The locking arrangement further includes a locking lever (60) secured to the housing; the locking lever (60) being movable to lock and unlock the service handle (58) into a position with the channel (64). The locking lever (60) is spring-loaded relative to the housing. A liquid collection bowl (52) and valve assembly (54) is in fluid communication with the upstream side (140) of the first filter element (136).

A method of filtering comprising: sucking a liquid from a reservoir using a pump (46) located in a housing (42) through an inlet port (72) in the housing, then through a first filter element (136) located in the housing, and then through the pump; and pushing the liquid from the pump through a second filter element (138) in the housing and then through an outlet port (74) in the housing. The step of sucking a liquid through a first filter element includes sucking the liquid through a pleated filter element. While sucking the liquid through the first filter element, separating water from the liquid and draining the water to a drainage bowl (52). The step of pushing the liquid through a second filter element includes pushing the liquid through a non-pleated element configured for axial flow. The step of sucking a liquid from a reservoir includes sucking fuel from a fuel tank (32).

A method of servicing a filter arrangement comprising: releasing a lever (60) to free a service handle (58); pulling the service handle (58) and removing a filter cartridge (50) from operable engagement with a housing (42); the filter cartridge including: a casing (124) having an outer surrounding wall (120) defining an interior volume (122), first and second fluid inlet ports (128, 130), and first and second fluid outlet ports (132, 134); each of the first inlet port, first outlet port, second inlet port, and second outlet port being fluidly isolated from each other; a first filter element (136) permanently secured within the interior volume of the casing; the first filter element having an upstream side (140) in flow communication with the first inlet port and a downstream side (142) in flow communication with the first outlet port; and a second filter element (138) permanently secured within the interior volume of the casing; the first filter element and the second filter element being fluidly isolated from each other; the second filter element having an upstream side (150) in flow communication with the second inlet port and a downstream side (152) in flow communication with the second outlet port. The step of releasing a lever includes pushing the lever against a spring biased against the housing. The step of pulling a service handle includes pulling a service handle defining a plurality of notches (112); and the step of removing a filter cartridge includes using a handle (92) secured to a cover (44) secured to the cartridge to pull pegs (62) secured to the cover from engagement with the notches.

A fuel system (22) comprising a filter arrangement as characterized above; and further comprising: a fuel tank (32) in fluid communication with the housing inlet port (72); and a fuel injection system (36) in fluid communication with the housing outlet port (74).

1-25. (canceled)

26. A filter cartridge comprising:
(a) a cartridge casing including an outer surrounding wall defining an interior volume;
(i) the cartridge casing including first and second fluid inlet ports and first and second fluid outlet ports;
(b) a first filter element permanently secured within the interior volume of the cartridge casing;
(i) the first filter element has an upstream side in flow communication with the first inlet port and a downstream side in flow communication with the first outlet port;
(c) a second filter element permanently secured within the interior volume of the cartridge casing;
(i) the second filter element has an upstream side in flow communication with the second inlet port and a downstream side in flow communication with the second outlet port;
(ii) the first inlet port is separated from the first outlet port by the first filter element;
(iii) the second outlet port is separated from the second inlet port by the second filter element;
(iv) the first inlet port and first outlet port are each completely separated from each of the second inlet port and second outlet port; and
(v) the first filter element and the second filter element are fluidly isolated from each other by internal wall structure of the casing.

27. A filter cartridge according to claim 26 wherein:
(a) at least the second filter element comprises non-pleated media configured for axial flow.

28. A filter cartridge according to claim 26 wherein:
(a) the cartridge casing includes wall structure in the interior volume of the outer surrounding wall separating the first filter element and the second filter element.

29. A filter cartridge according to claim 27 wherein:
(a) the first filter element circumscribes the second filter element.

30. A filter cartridge according to claim 27 wherein:
(a) the first filter element comprises pleated media in a tubular shape with an open filter interior, and
(b) the second filter element is oriented in the open filter interior of the first filter element.

31. A filter cartridge according to claim 27 wherein:
(a) the first filter element and the second filter element are each non-round in cross-section.

32. A filter cartridge according to claim 27 wherein:
(a) the first filter element and the second filter element are each obround in cross-section.

33. A filter cartridge according to claim 26 wherein:
(a) the cartridge has first and second axial ends;
(i) the first axial end being closed; and
(ii) the second axial end being open and defining the first inlet and outlet port and the second inlet and outlet port.

34. A filter cartridge according to claim 33 wherein:
(a) the first filter element and the second filter element are separated within the cartridge by wall structures extending from the second axial end at least partially to the first axial end.

35. A filter arrangement comprising the filter cartridge according to claim 26;
the filter arrangement comprising:
(a) a housing defining an interior volume and an opening providing access to the interior volume; the filter cartridge being removably oriented in the interior volume of the housing; the housing defining a housing inlet port and a housing outlet port;
(i) the housing inlet port is in fluid communication with the first inlet port;
(ii) the housing outlet port is in fluid communication with the second outlet port; and
(b) a pump oriented in the housing; the pump having a pump inlet port and a pump outlet port;
(i) the pump inlet port being in fluid communication with the first outlet port; and
(ii) the pump outlet port being in fluid communication with the second inlet port.

36. A filter arrangement according to claim 35 further comprising:
(a) a cover removably oriented over the opening in the housing; and the cover being removably secured to the filter cartridge.

37. A filter arrangement according to claim 36 further comprising:
(a) a locking arrangement to permit selective operable installation and removal of the filter cartridge relative to the housing.

38. A filter arrangement according to claim 37 wherein:
(a) the locking arrangement includes:
(i) a plurality of pegs extending from the cover;
(ii) a channel defined by the housing; the housing also including a plurality of holes in communication with the channel; the holes sized to receive the pegs; and
(iii) a service handle including a plurality of notches; and
(b) the service handle is slidable in the channel defined by the housing such that the notches align with the holes and permit the pegs on the cover to pass through the holes and notches.

39. A filter arrangement according to claim 38 wherein:
(a) the locking arrangement further includes a locking lever secured to the housing;
(i) the locking lever being movable to lock and unlock the service handle into a position with the channel.

40. A filter arrangement according to claim 39 wherein:
(a) the locking lever is spring-loaded relative to the housing.

41. A filter arrangement according to claim 35 including:
(a) a liquid collection bowl and valve assembly in fluid communication with the upstream side of the first filter element.

42. A method of filtering comprising:
(a) sucking a liquid from a reservoir using a pump located in a housing through an inlet port in the housing, then through a first filter element located in the housing, and then through the pump; and
(b) pushing the liquid from the pump through a second filter element in the housing and then through an outlet port in the housing.

43. A method according to claim 42 wherein:
(a) the step of sucking a liquid through a first filter element includes sucling the liquid through a pleated filter element.

44. A method according to claim 42 further comprising:
(a) while sucking the liquid through the first filter element, separating water from the liquid and draining the water to a drainage bowl.

45. A method according to claim 43 wherein:
(a) the step of pushing the liquid through a second filter element includes pushing the liquid through a non-pleated element configured for axial flow.

46. A method according to claim 42 wherein:
(a) the step of sucking a liquid from a reservoir includes sucking fuel from a fuel tank.

47. A method of servicing the filter arrangement according to claim 35; the method comprising:
(a) releasing a lever to free a service handle; and
(b) pulling the service handle and removing the filter cartridge from operable engagement with the housing.

48. A method according to claim 47 wherein:
(a) the step of releasing a lever includes pushing the lever against a spring biased against the housing.

49. A method according to claim 47 wherein:
(a) the step of pulling a service handle includes pulling a service handle defining a plurality of notches; and
(b) the step of removing a filter cartridge includes using a handle secured to a cover secured to the cartridge to pull pegs secured to the cover from engagement with the notches.

50. A fuel system comprising a filter arrangement according to claim 35; and further comprising:
(a) a fuel tank in fluid communication with the housing inlet port; and
(b) a fuel injection system in fluid communication with the housing outlet port.
